(19) United States
(12) Patent Application Publication
(10) Pub. No.: US 2026/0073465 A1
(43) Pub. Date: Mar. 12, 2026

(54) Event Identification and Management System

(71) Applicant: Disaster Technologies Incorporated, Alexandria, VA (US)

(72) Inventors: Roger V. Coleman, Plandome, NY (US); Sean Griffin, Alexandria, VA (US); Jason C. Shafer, Pittsburgh, PA (US); Nikko Mitrano Schaff, Montour Falls, NY (US); Madiha Jafri, Moorestown, NJ (US); Katherine Herleman, Montour Falls, NY (US)

(21) Appl. No.: 19/107,805

(22) PCT Filed: Aug. 29, 2023
(86) PCT No.: PCT/US23/73034

§ 371 Date: Feb. 28, 2025

Related U.S. Application Data
(60) Provisional application No. 63/373,944, filed on Aug. 30, 2022.

(51) Int. Cl. G06Q 50/26; G06Q 50/00

(52) U.S. Cl. CPC G06Q 50/265; G06Q 10/40

(57) ABSTRACT

An anomalous/hazardous event or incident identification and response coordination system is provided. Events or incidents that could pose threats to people, property, and/or reputation are identified based on data received from a variety of sources that is filtered based on parameters associated with each user of the system and run through appropriate classifier models. When a potential event is identified, an alert is sent to an appropriate user of the system and the user may confirm, reject, or otherwise modify the event's classification. If the user indicates that a response may be necessary, a pre-established response plan is selected based on the nature and/or severity of the event. Certain aspects of the selected plan may be pre-determined based on the event type and the information received that generated the event alert. The response plan may then be distributed to appropriate personnel and executed, and updated data is provided as warranted.

### FIELD OF THE INVENTION

The present invention generally relates to the field of incident prediction and monitoring. In particular, the present invention is a system and method for identification and response management of anomalous or hazardous events.

### BACKGROUND

Incidents that may create risks for individuals, property, and/or reputation are often unexpected or unplanned, making identification, classification, and responding to them in an efficient and timely manner difficult. A delayed response or misallocation of resources can negatively impact the effectiveness of a response. There is a need for identifying and efficiently facilitating the coordination of responses prior to and during incidents that pose potential risks, such as extreme weather-related events.

### SUMMARY OF THE DISCLOSURE

A method for identifying and managing an event includes identifying a user, associating a plurality of parameters with the user, receiving data from a plurality of sources, filtering the data based on the plurality of parameters to generate a subset of data, determining a category of the subset of data, inputting the filtered data into a classifier module based on the category of the subset of data and the plurality of parameters, identifying the event based on outputs of the classifier module, wherein the event is identified as ongoing or upcoming and the outputs includes a set of values, associating a set of event data with the event, sending an alert and the set of event data to one or more accounts associated with the user if one or more of the values in the set of values of the outputs exceed one or more respective thresholds, wherein the thresholds are associated with the user, and receiving input from the user for classifying the event.

Additionally or alternatively, the plurality of parameters includes a geographic area and a type of hazardous event.

Additionally or alternatively, if the input from the user classifies the event as not a significant threat, the input, the plurality of parameters, and the set of values are recorded in a database of the classifier module.

Additionally or alternatively, if the input from the user classifies the event as a significant threat, the alert and the set of event data are sent to additional accounts associated with the user based on a rating of event severity.

Additionally or alternatively, if the input from the user classifies the event as a significant threat, a planning form is selected based on a type of the identified event.

Additionally or alternatively, a plurality of fields of the selected planning form are filled with information based on the event and the user.

Additionally or alternatively, additional data is received after sending the alert, associating at least some of the additional data with the identified event, and sending an update to the user that includes the at least some of the additional data.

Additionally or alternatively, the plurality of sources includes social media sources.

Additionally or alternatively, the plurality of sources includes newspaper reports.

Additionally or alternatively, the data includes sustained wind speed, peak wind gust, and wind direction.

Additionally or alternatively, the one or more thresholds include a wind speed value and a precipitation amount.

Additionally or alternatively, the input from the user classifies the event as no risk of hazardous event, low risk of hazardous event, moderate risk of hazardous event, high risk of hazardous event or severe risk of hazardous event.

Additionally or alternatively, the alert includes a confidence level and a potential risk level for the event.

In another aspect, a method of preparing a response plan includes identifying a user, associating a plurality of parameters with the user, receiving data from a plurality of sources, filtering the data based on the plurality of parameters to generate a subset of data, determining a category of the subset of data, inputting the filtered data into a classifier module based on the category of the subset of data and the plurality of parameters, identifying an event based on outputs of the classifier module, wherein the event is identified as ongoing or upcoming and the outputs includes a set of values, associating a set of event data with the event, sending an alert and the set of event data to one or more accounts associated with the user if one or more of the values in the set of values of the outputs exceed one or more respective thresholds, wherein the thresholds are associated with the user, receiving input from the user for classifying the event, selecting a plan response form based on a type of the identified event if the input from the user classifies the event as an actionable event, filling a plurality of fields of the selected plan response form with information based on the event and the user, and sending the plan response form to the user.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a process diagram for identifying a potential hazardous event or incident in accordance with an aspect of the present invention;

FIG. 2 is a process diagram for classifying an identified event or incident and preparing a response plan for that event or incident as well as providing updated information about that event or incident in accordance with the present invention; and

FIG. 3 is a grid with confidence level of an event occurring against the potential impact of increasing wind speeds for determining overall risk or consequence and whether action is required in accordance with an embodiment of the present invention.

### DESCRIPTION OF THE DISCLOSURE

An anomalous/hazardous event identification and response coordination system is provided. At a high level, events or incidents that could pose threats to people, property, and/or reputation are identified based on data received from a variety of sources. Received data is processed to identify potential or ongoing events or incidents as well as the likelihood and severity of the identified events or incidents. When a potential event or incident is identified and determined to meet certain thresholds related to likelihood and/or severity, an alert is sent to an appropriate user (e.g., a subscriber) of the system and the user may confirm, reject, or otherwise modify the incident or event's classification. If the user indicates that a response may be necessary, a pre-established response plan is selected based on the nature, cause, location, and/or severity of the incident or event. Certain information for the selected plan may be pre-determined based on the event or incident type and the received data that generated the alert. The response plan may then be distributed to appropriate personnel and executed, and updates are provided as warranted to the user with additional data and/or alert levels. As used herein, the term “event” refers to any currently ongoing or potential situation, incident, or other circumstance that may be anomalous, hazardous, or otherwise of interest to a user that needs to monitor and/or respond to such occurrences.

In an embodiment, one or more users, such as customers or subscribers, are set up with accounts on a risk flow management system. Each user will have associated parameters related to the user's areas of concern, which may include one or more geographic areas and topics, such as extreme weather-related events or civil disruptions. Each user will also select personnel within their organization that will receive alerts, data, and updates from the risk flow management system as described below in addition to which personnel will have permissions to classify identified incidents or events and to access data provided.

In operation, data is received by the risk flow management system from a variety of sources in order to be classified and processed to identify potential risks in a manner that may be tailored for each user. The received data may include digital channels including social media, online blogs, and other media sources such as newspapers and their digital versions. In addition, environmental data, which can include observations or predictions from weather forecast information, may be included along with other sources of particularized data for measurements related to certain topics. Weather information, for example, may include wind information (e.g., sustained speed, peak gust, and direction) at specific locations or derived statistics across a geospatial area during a period of time. In addition, user-specific and/or user-selected data sources may provide data, which may include data from or associated with a user's facilities or equipment, for example. The user-specific data is not generally used as part of the modeling for or made available to other users.

All of the received data is loaded into modeling or classifying programs that are appropriate based on the type of data. For example, the social media data is received in text format and used in natural language processing. Weather data is converted to numeric information after geospatial analytics derive specific risk qualifying information. Base weather input data may include point or gridded data. Further, different classifiers or different sets of classifiers may be used for different users based on each user's associated parameters, such as geographic areas and topics. These parameters serve as filters for the incoming raw data, e.g., data related to events or incidents outside a user's geographic area may be discarded. This data is received, either periodically or on-demand, by a database or data management system through a continuously scheduled extract-transform-load program. The classifiers are also selected based on the nature of the risk data, and users may select which classifier is used for them. For example, extreme weather data, electric grid infrastructure information, and other electric grid resilience factors may be input into a power outage prediction model that categorizes the risk of power outage duration across a geographic area. Social media data is entered into an aggregator or hazardous event classifier.

For each user, the data that has been filtered based on that user's parameters is then run through an appropriate classifier model or set of classifier models for that user in order to determine whether an event of interest to that user has occurred or might be likely to occur. These determinations are made by the identification of data that is indicative of the occurrence or likely occurrence of an event of interest to a user. For some data, this may be done by natural language processing, and for other data it may be based on specific values received, such as measurements related to extreme weather hazards, such as wind information (e.g., sustained speed, peak gust, and direction). Event determinations may also stem from trends gleaned from the aggregation of similar data and output values stemming from those aggregations. These values may be associated with certain confidence levels of the determinations.

When the classifier determines that an event of interest to a particular user is occurring or might occur, the event is identified and an alert is sent to the selected personnel of that user as determined by the user. Whether an alert is sent to a particular user is determined by whether certain thresholds, as set by the user, are met by the output values of the classifier. These thresholds may be for specific physical values, such as wind information or precipitation amounts, or may be for certain types of identified anomalies or incidents. In either case, the alert will be sent when a certain confidence level is reached, i.e., once the classifier determines that the received data and what the received data is indicative of is sufficiently likely to be accurate. The thresholds may be adjusted by a user for that user's alert settings.

Users of the system may select which classifiers are used for analyzing received risk data based on the types of events of interest. The selected classifiers receive the risk data and make an initial determination of whether a significant threat exists or whether there is a chance that a hazardous event will occur. Based on thresholds related to the confidence level in the determination by the classifiers of the existence/possible occurrence of an event and the level of overall risk or consequence, an alert may be sent to a user.

Alerts are sent to selected personnel based on notification hierarchies set up by users, which may be based on their organizational structure and reporting requirements. For example, a supervisor on duty might receive notifications about all information of significance, e.g., including lower-level alerts. If the risk level or certain data values exceed a higher threshold, then supervisors above the level of the supervisor on duty would be notified as well, with the particular personnel receiving alerts depending on the severity of the event.

When an alert is sent to a user, all data related to the relevant event is sent to the user as well. For example, if a possible event is identified based on a single post or message, the content of that post or message will be sent with the alert. Likewise, if the event determination is based on one or more specific values, such as wind speed, that data will be sent with the alert. In addition, the threshold levels, as well as other pertinent outputs of the models, may be made available to the selected personnel that receive the alert. Further, updates will be sent to the user that include new data that is determined to be associated with the identified event for which an alert has been previously sent (unless that event has been marked as completed or classified as a non-event by the user), as well as any updates to the confidence levels or the values used for threshold determinations. The classifiers determine whether newly incoming data is related to an identified event and associate that data with the identified event so long as the event is considered active.

Based on the alert, which may include a confidence level as well, the user can make a user-determination (i.e., confirm, hold for further review, or decline the classifier determination) about the event that the alert identified, as well as decide whether action is required. If the user determines that no action is required or that it is a non-event, that indication is sent back to an associated database in order to be used as a data point to improve the accuracy of the determinations. If the user determines that action is required, that indication may be sent back to the database in order to be used as a data point to improve the accuracy of the determinations. Accuracy can be determined by the likelihood of event detection (e.g., hit, miss, false alarm, correct rejection) or other statistical metrics (e.g., mean absolute error, mean absolute percentage error). The user may also choose to hold or put the event in a wait-and-see mode. In this case, the risk flow management system will continue to provide updates and new data related to the identified event so that the user can continue to monitor the situation, which may lead to a subsequent user-determination about that event.

To this end, the user-determination of potential events received in alerts may be any of several possible classifications, which may include: no predicted hazardous event (in which case no action might be required); low risk of hazardous event (in which case a “keep watch” might be instituted whereby information related to the potential event will continue to be monitored); moderate risk of hazardous event (in which case need-to-know personnel will be notified); high risk of hazardous event (in which case an incident response will be initiated and need-to-know personnel will be notified); or severe risk of hazardous event (in which case an incident response will be initiated and all personnel with a role in the response will be notified).

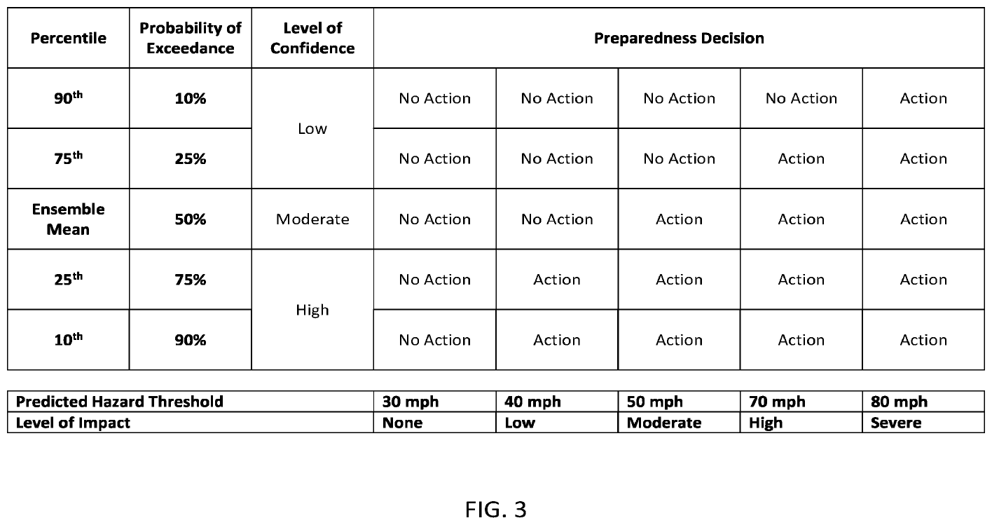

In order to assess the overall risk or consequence, and in turn whether action is to be taken, a level of confidence in the determination of an event is used in conjunction with the level of potential impact. For example, the confidence in the prediction that an event may occur or is occurring may be low, moderate, or high, and the level of impact from the hazardous event may be no impact, low, moderate, high, or severe. For some users, action may be initiated if the level of impact is severe even if the confidence in the prediction is low. Similarly, a high confidence level in the prediction that an event will occur may result in action being initiated although the level of impact is likely to be more moderate. An example is given in FIG. 3, which shows a grid of confidence levels of an event occurring against the potential impact of increasing wind speeds. In this way, the level of confidence that a given hazardous event will occur is combined with the expected level of impact of that hazardous event. The preparedness decision, or determination of action/no action, for each combination may vary depending on the user's preferences, which may be based on the type of impact of concern to the user.

For known extreme weather hazards, the level of confidence can be provided by a probability or likelihood of occurrence based on the predicted outcome for each hazard (e.g., wind, precipitation amount). This level of confidence can be statistically derived based on a normalized distribution given a plurality of weather forecast models. For example, at one point in space and time the maximum predicted wind gusts can be shown for different forecast percentiles, which can be translated to probability exceedance thresholds. For a normalized distribution, the 90th percentile value would be only likely to occur 10% of the time. Additionally, other factors such as the forecast lead time (how far ahead of a potential event) can be used to enrich user understanding of confidence. Translating confidence to probability assists users in conducting scenario-based risk evaluation, which helps to remove subjectivity and better target actions to operating procedures.

When a user determines that action is required in response to an event, the user may send the alert and/or related data to other personnel. In addition, one or more response forms may be selected and returned to the user with some data fields pre-filled. The forms are selected based on the nature of the event as well as other factors such as location and severity, in addition to the user's identity and preferences.

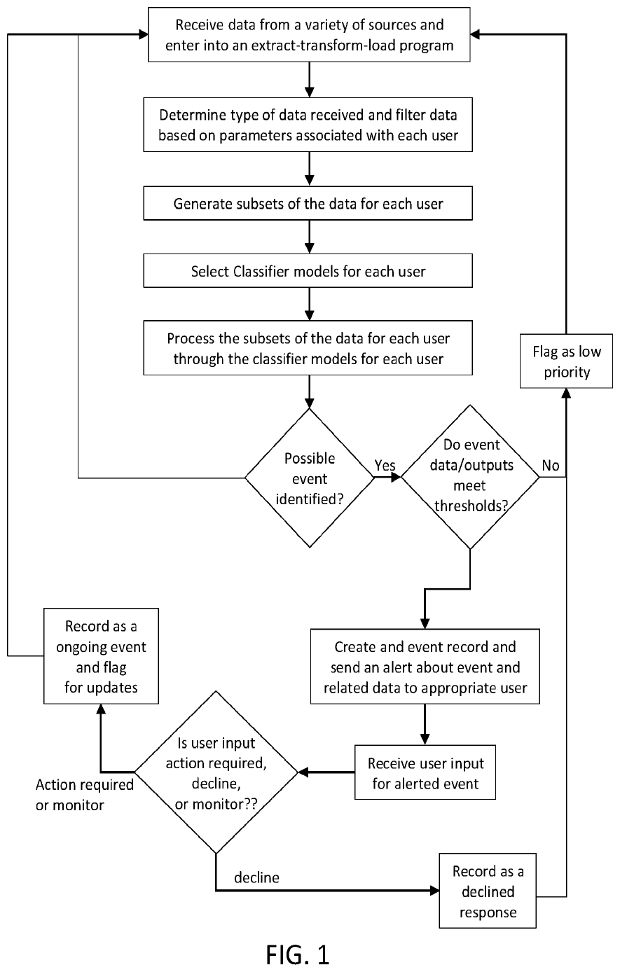

In FIG. 1, an overview is provided for a process for identifying an event that poses a potential threat. Data (as described above) is received continually or on-demand by the risk flow management system from a variety of sources, regardless of any particular user. This data is then filtered for each user based on parameters associated with each user to generate a subset of data to be processed for each user. The subsets of data are run through one or more classifier models for each respective user. The classifier models are selected based on user parameters and/or preferences. For each user, the classifier models determine whether an event is occurring or is likely to occur. This determination involves comparing output values to thresholds and, optionally, confidence levels. If the requisite thresholds and confidence levels are met, an alert is sent to selected personnel of the user along with related data and/or output values. If not, the potential event is flagged as low priority.

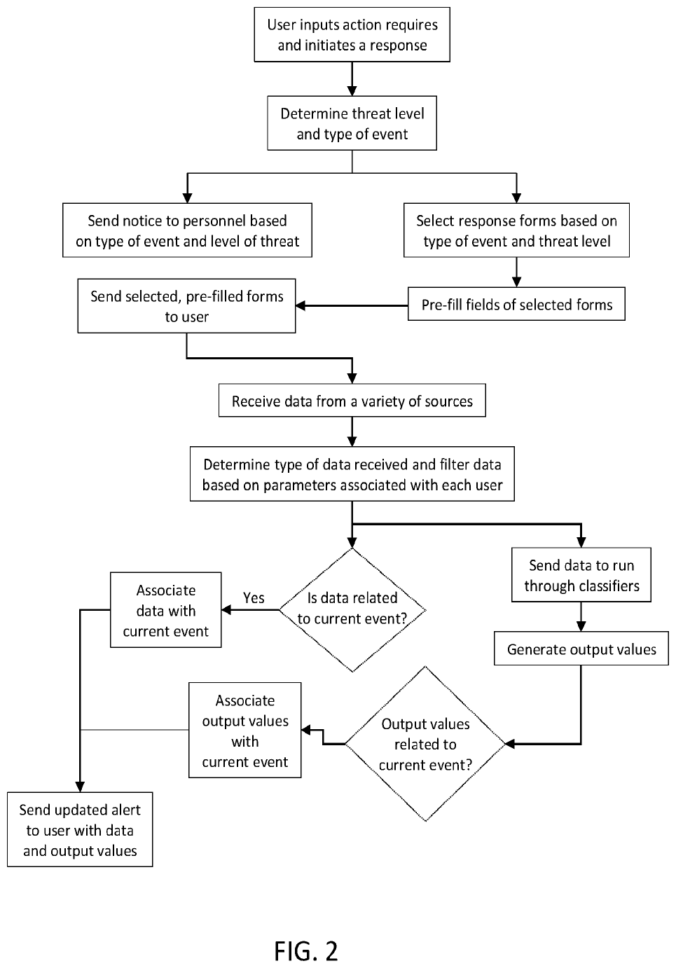

In FIG. 2, a process diagram is shown in which the user receives the alert and any associated data or outputs and based on that information makes a user-determination as to whether the identified event is a significant threat. If not, the identified event is recorded as a declined response in the database of the risk flow management system, which can be used for improving future assessments. If the user determines that the event is a significant threat, a response is initiated.

Once the user determines that an event for which an alert was received requires a response, the user inputs the event classification, which may be suggested by the classifier in the alert based on the confidence level and potential risk level. Other related data may be used to inform this determination, such as the nature of the threat. Notice of the event is then sent to selected personnel in the user's organization based on the type of event and the level of threat. In addition, response and planning forms may be selected based on the user, event type and threat level, as well as other factors such as geographical location. The selected forms may be pre-filled in part based on such information and classification and sent to the user and other selected users if appropriate.

Because many events are ongoing, after a response is initiated or if an alert is marked as requiring subsequent monitoring and evaluation, updated information will be required. Updated information is provided to the user about events which have been previously identified by the system and for which an alert had been previously sent to the user. Each identified event is associated with the data and/or output values that formed the basis of the initial identification of the occurring or possible event. Any newly received data that is determined to be related to an identified event is also associated with that event. Similarly, updated output values related to the identified event are associated with that event. These associated values and data are sent to the user in the form of updates associated with the previously sent alert for that event, either periodically, on demand from the user, or based on the amount of data or magnitude of changes in outputs, for any event that the user has marked as requiring action or continued monitoring and that has not been marked as terminated.

In this way, data from the variety of sources will continue to be received by the system for all users and events are continuously identified for all users while updates with new data and/or outputs associated with an alerted event are provided to users that received an alert. It is determined whether the newly received data is related or pertinent to the current event for which a response has been initiated, and if so, updated data is prepared and sent to the user, who may modify the determined threat level of the event based on the new information. For newly incoming data received that is not related to the current event, it is run through the classifiers as described above to identify other, unrelated events in the manner described above.

The planning and operations forms that are pre-filled and sent to the user are selected based on the nature, cause, severity, and/or location of the identified event as well as the identity of the user. These forms are at least partially filled with information in certain fields based on information about the event, such as location, type, magnitude (e.g., size of affected area or number of people at risk) and severity. These fields may include personnel to be contacted, supplies required, time limits for taking particular action, or communications to be made (e.g., to media outlets).

Certain data may be related to certain types of events or incidents. For example, wind speed can be a critical component of wind storms, wildfires, and hurricanes, so planning and operations forms can be selected that are designed for those types of events and those forms may include pertinent risk data. Further, data or output values meeting particular thresholds can also be used to select which type of pre-existing plan to recommend for the user, as different levels of severity of risk may be associated with different forms and/or inputting different pre-determined values into the selected forms. For example, high speed wind and heavy precipitation are more likely to be found during a hurricane than a wildfire, and so the hurricane plan form will be presented to the user as the recommended plan of action when the data meets certain thresholds for both wind speed and precipitation (whether predicted or current).

Once a response plan is selected and the user completes the plan to the extent necessary, e.g., by altering or filling in fields of the form, the response plan is executed. During the implementation period of the response, any additional risk data related to the event for which the response is being taken will be continuously received and used to inform the users and optionally responders about any changes related to the event.

Once a user determines that the event has ended (for purposes of the user), the user inputs commands to conclude, demobilize, and archive the event once the threat conditions have passed.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. A method for identifying and managing an event comprising:
identifying a user;
associating a plurality of parameters with the user;
receiving data from a plurality of sources;
filtering the data based on the plurality of parameters to generate a subset of data;
determining a category of the subset of data;
inputting the filtered data into a classifier module based on the category of the subset of data and the plurality of parameters;
identifying the event based on outputs of the classifier module, wherein the event is identified as ongoing or upcoming and the outputs includes a set of values;
associating a set of event data with the event;
sending an alert and the set of event data to one or more accounts associated with the user if one or more of the values in the set of values of the outputs exceed one or more respective thresholds, wherein the thresholds are associated with the user; and
receiving input from the user, wherein the input classifies the event.

2. The method of claim 1, wherein the plurality of parameters includes a geographic area and a type of hazardous event.

3. The method of claim 1, further including, if the input from the user classifies the event as not a significant threat, recording the input, the plurality of parameters, and the set of values in a database of the classifier module.

4. The method of claim 1, further including, if the input from the user classifies the event as a significant threat, sending the alert and the set of event data to additional accounts associated with the user based on a rating of event severity.

5. The method of claim 1, further including, if the input from the user classifies the event as a significant threat, selecting a planning form based on a type of the identified event.

6. The method of claim 5, further including filling a plurality of fields of the selected planning form with information based on the event and the user.

7. The method of claim 1, further including receiving additional data after sending the alert, associating at least some of the additional data with the identified event, and sending an update to the user that includes the at least some of the additional data.

8. The method of claim 1, wherein the plurality of sources includes social media sources.

9. The method of claim 8, wherein the plurality of sources includes newspaper reports.

10. The method of claim 9, wherein the data includes sustained wind speed, peak wind gust, and wind direction.

11. The method of claim 10, wherein the one or more thresholds include a wind speed value and a precipitation amount.

12. The method of claim 11, wherein the input from the user classifies the event as no risk of hazardous event, low risk of hazardous event, moderate risk of hazardous event, high risk of hazardous event or severe risk of hazardous event.

13. The method of claim 12, wherein the alert includes a confidence level and a potential risk level for the event.

14. A method of preparing a response plan comprising:
identifying a user;
associating a plurality of parameters with the user;
receiving data from a plurality of sources;
filtering the data based on the plurality of parameters to generate a subset of data;
determining a category of the subset of data;
inputting the filtered data into a classifier module based on the category of the subset of data and the plurality of parameters;
identifying an event based on outputs of the classifier module, wherein the event is identified as ongoing or upcoming and the outputs includes a set of values;
associating a set of event data with the event;
sending an alert and the set of event data to one or more accounts associated with the user if one or more of the values in the set of values of the outputs exceed one or more respective thresholds, wherein the thresholds are associated with the user;
receiving input from the user, wherein the input classifies the event;
selecting a plan response form based on a type of the identified event if the input from the user classifies the event as an actionable event;
filling a plurality of fields of the selected plan response form with information based on the event and the user; and
sending the plan response form to the user.

15. The method of claim 14, further including receiving additional data after sending the alert, associating at least some of the additional data with the identified event, and sending an update to the user that includes the at least some of the additional data.

16. The method of claim 15, wherein the plurality of sources includes social media sources.

17. The method of claim 16, wherein the plurality of sources includes newspaper reports.

18. The method of claim 17, wherein the data includes sustained wind speed, peak wind gust, and wind direction.

19. The method of claim 18, wherein the one or more thresholds include a wind speed value and a precipitation amount.

20. The method of claim 19, wherein the input from the user classifies the event as no risk of hazardous event, low risk of hazardous event, moderate risk of hazardous event, high risk of hazardous event, or severe risk of hazardous event.

21. The method of claim 20, wherein the alert includes a confidence level and a potential risk level for the event.

22. The method of claim 21, further including sending, with the alert, a recommendation for taking action based on a combination of the confidence level and the potential risk level for the event.

23. The method of claim 14, wherein the plurality of parameters includes a geographic area and a type of hazardous event.
